(19) United States
(12) Patent Application Publication
(10) Pub. No.: US 2016/0044582 A1
(43) Pub. Date: Feb. 11, 2016

(54) METHOD TO ACCELERATE MANUAL PUBLIC LAND MOBILE NETWORK SEARCH IN DUAL-SIM DUAL-ACTIVE DEVICES

(71) Applicant: QUALCOMM Incorporated, San Diego, CA (US)

(72) Inventors: Srinivasarao Pasumarthi, Hyderabad (IN); Ravi Kanth Kotreka, Hyderabad (IN)

(21) Appl. No.: 14/453,535

(22) Filed: Aug. 6, 2014

(51) Int. Cl. H04W 48/16

(52) U.S. Cl. CPC H04W 48/16; H04W 84/042

(57) ABSTRACT

A method for public land mobile network (PLMN) search on a mobile communication device includes: initiating a PLMN search for a first plurality of radio access technologies (RATs) associated with a first subscription; determining whether one or more of the first plurality of RATs associated with the first subscription are also associated with a second subscription; and performing a PLMN search for the one or more of the first plurality of RATs that are also associated with the second subscription using an RF chain associated with the second subscription.

### BACKGROUND

In a Dual-Subscriber Identity Module, Dual-Active (DSDA) mobile communication device most of the activities for each subscription are carried out on an radio frequency (RF) chain designated for each subscription. For example, with both subscriptions in service and performing idle mode operations, each subscription is transmitting and/or receiving using the RF chain designated for that subscription. If a Public Land Mobile Network (PLMN) search is initiated on a first subscription, the RF chain designated for the first subscription (e.g., RF Chain1) will be used to scan the available cells in the vicinity for a list of PLMNs in the Radio Access Technologies (RATs) supported by the first subscription, while the RF chain designated for the second subscription (e.g., RF Chain2) may be idle.

### SUMMARY

Apparatuses and methods for accelerating PLMN search are provided.

According to various embodiments there is provided a method for public land mobile network (PLMN) search on a mobile communication device. The method may include: initiating a PLMN search for a first plurality of radio access technologies (RATs) associated with a first subscription; determining whether one or more of the first plurality of RATs associated with the first subscription are also associated with a second subscription; and performing a PLMN search for the one or more of the first plurality of RATs that are also associated with the second subscription using an RF chain associated with the second subscription.

According to various embodiments there is provided a method for public land mobile network (PLMN) search on a mobile communication device. The method may include: initiating a PLMN search for a radio access technologies (RAT) associated with a first subscription; determining one or more frequency bands from a plurality of frequency bands for the RAT to be searched using an RF chain associated with a second subscription; and performing a PLMN search for the one or more determined frequency bands for the RAT associated with the first subscription using the RF chain associated with the second subscription.

According to various embodiments there is provided a mobile communication device. The mobile communication device may include: a first RF chain associated with a first plurality of RATs, wherein the first plurality of RATs is associated with a first subscription; a second RF chain associated with a second plurality of RATs, wherein the second plurality of RATs is associated with a second subscription; and a control unit configured to: determine whether one or more of the first plurality of RATs are also common to the second plurality of RATs, and perform a public land mobile network (PLMN) search for the one or more of the first plurality of RATs common to the second plurality of RATs using the second RF chain.

According to various embodiments there is provided a mobile communication device. The mobile communication device may include: a first RF chain associated with a first plurality of RATs, wherein the first plurality of RATs is associated with a first subscription; a second RF chain associated with one or more second RATs; and a control unit configured to: determine one or more frequency bands from a plurality of frequency bands for one of the first plurality of RATs to perform public land mobile network (PLMN) search using the second RF chain, and perform a PLMN search on the one or more determined frequency bands using the second RF chain.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a block diagram illustrating a mobile communication device according to various embodiments;

FIG. 2 is a block diagram illustrating first and second communications units according to various embodiments;

FIG. 3 is a flowchart of a method for accelerating background and/or foreground PLMN search according to various embodiments; and

FIG. 4 is a flowchart of a method for accelerating background and/or foreground PLMN search according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

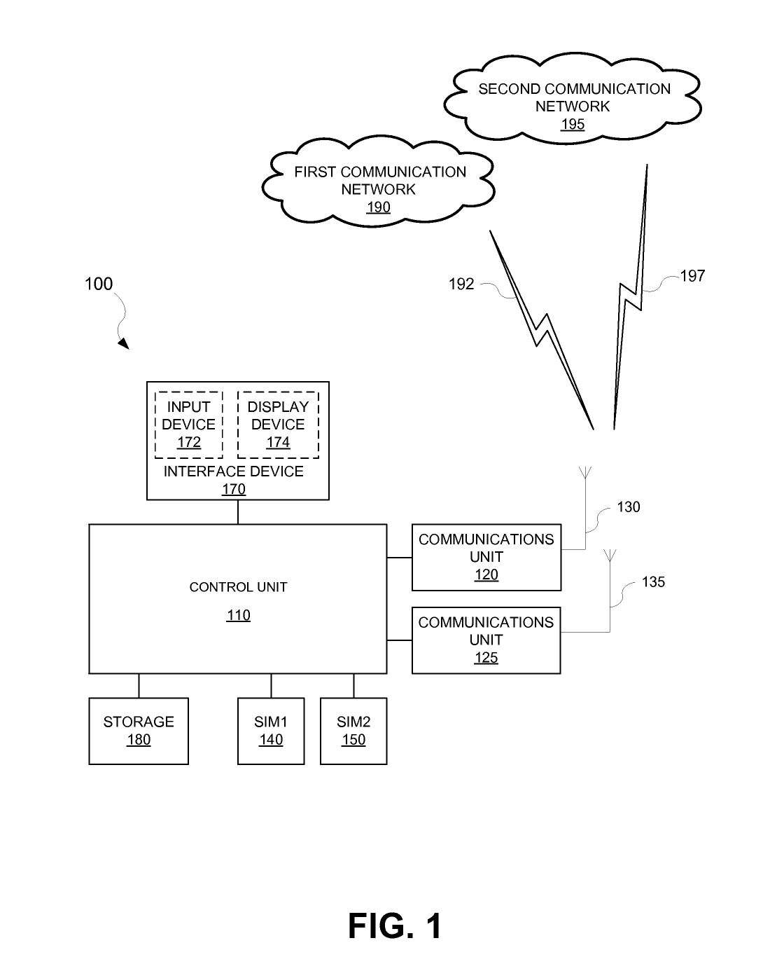

FIG. 1 is a block diagram illustrating a mobile communication device according to various embodiments. As illustrated in FIG. 1, the mobile communication device 100 may include a control unit 110, a first communications unit 120, a second communications unit 125, a first antenna 130, a second antenna 135, a first subscriber identity module (SIM) 140, a second SIM 150, a user interface device 170, and a storage 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communications units) and may interface with one or more antennas without departing from the scope of the present inventive concept.

The first SIM 140 may associate the first communications unit 120 with a first subscription (Sub1) 192 on a first communication network 190 and the second SIM 150 may associate the second communications unit 125 with a second subscription (Sub2) 197 on a second communication network 195. For convenience, throughout this disclosure Sub1 is associated with the first communications unit 120 and Sub2 is associated with the second communications unit 125. One of ordinary skill in the art will appreciate that either subscription may be associated with either communications unit without departing from the scope of the present inventive concept.

The first communication network 190 and the second communication network 195 may be operated by the same or different service providers, and/or may support the same or different communication technologies, for example, but not limited to, Wideband Code Division Multiple Access (WCDMA), Global System for Mobile communications (GSM), Long Term Evolution (LTE), Time Division-Synchronous Code Division Multiple Access (TD-SCDMA), etc.

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the present inventive concept.

The control unit 110 may be configured to control overall operation of the mobile communication device 100 including control of the first and second communications units 120, 125, the user interface device 170, and the storage 180. The control unit 110 may be a programmable device, for example, but not limited to, a microprocessor or microcontroller.

The storage 180 may be configured to store application programs necessary for operation of the mobile communication device 100 that are executed by the control unit 110, as well as application data and user data.

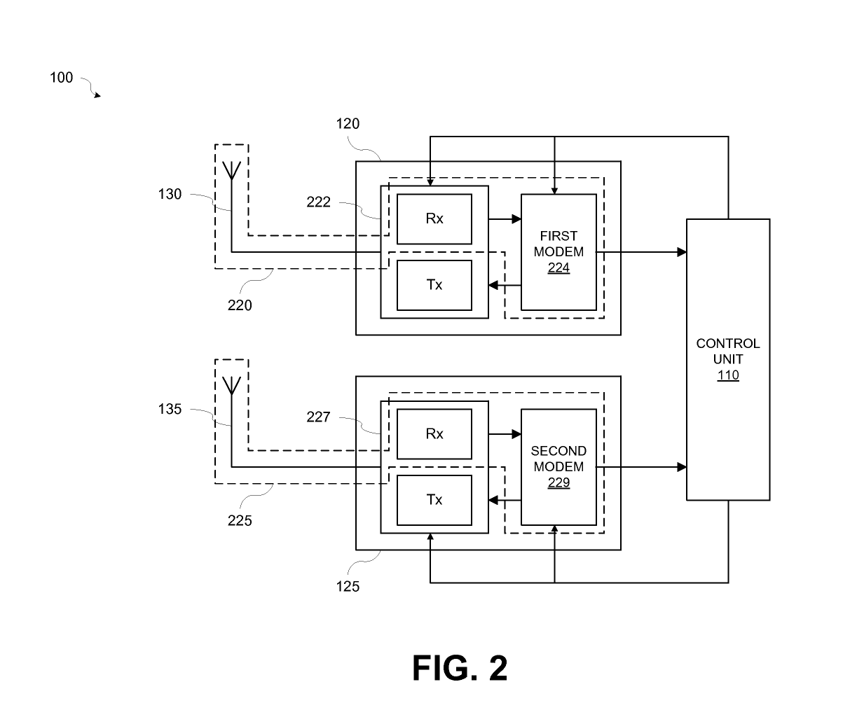

FIG. 2 is a block diagram illustrating first and second communications units 120, 125 according to various embodiments. Referring to FIGS. 1 and 2, the first communications unit 120 may include, for example, but not limited to, a first transceiver 222 and a first modem 224. The first transceiver 222 may receive signals from and supply signals to the first modem 224. The first transceiver 222 may process the signals received from the first modem 224 for transmission as RF signals via the first antenna 130, and may process RF signals received via the first antenna 130 and supply the processed signals to the first modem 224. In various embodiments, a first RF chain 220 may include the first transceiver 222, the first modem 224, and the first antenna 130.

The first communications unit 120 may be configured to communicate on one or more RATs. In active mode, the first communications unit 120 may receive and transmit signals. In idle mode, the first communications unit 120 may receive but not transmit signals.

The second communications unit 125 may include, for example, but not limited to, a second transceiver 227 and a second modem 229. The second transceiver 227 may receive signals from and supply signals to the second modem 229. The second transceiver 227 may process the signals received from the second modem 229 for transmission as RF signals via the second antenna 135, and may process RF signals received via the second antenna 135 and supply the processed signals to the second modem 229. In various embodiments, a second RF chain 225 may include the second transceiver 227, the second modem 229, and the second antenna 135.

The second communications unit 125 may be configured to communicate on one or more RATs. In active mode, the second communications unit 125 may receive and transmit signals. In idle mode, the second communications unit 125 may receive but not transmit signals.

One of ordinary skill in the art will appreciate that a separate transmitter and receiver may be used in place or a transceiver without departing from the scope of the present inventive concept.

In various embodiments, each subscription may be associated with one or more RATs. For example, Sub1 192 may be associated with a first plurality of RATs, for example, GSM, WCDMA, TD-SCDMA, and LTE RATs, and Sub2 197 may be associated with a second plurality of RATs, for example, GSM and LTE RATs. In some embodiments, the second subscription may be associated with only one RAT. One of ordinary skill in the art will appreciate that these are only non-limiting examples and other combinations are possible.

In various embodiments, background and/or foreground PLMN searches for RATs on one subscription may be divided between RF chains based on RATs common to both subscriptions and the searches performed in parallel. For the example above, if a PLMN search is initiated for the first plurality of RATs on Sub1 192, the control unit 110 may cause the PLMN searches for one or more of the first plurality of RATs, for example, the WCDMA and TD-SCDMA RATs, to be performed using the first RF chain 220 of the first communications unit 120, and the PLMN searches for one or more of the first plurality of RATs common to the second plurality of RATs, for example, the GSM and LTE RATs, to be performed simultaneously using the second RF chain 225 of the second communications unit 125. The PLMN searches for the

Sub1 192 RATs using the second RF chain 225 may performed during inactive periods of the Sub2 197 RATs while the Sub2 197 RATs are in idle mode. Decoded search data from the first modem 224 and the second modem 229 may be sent to the control unit 110 to be collated.

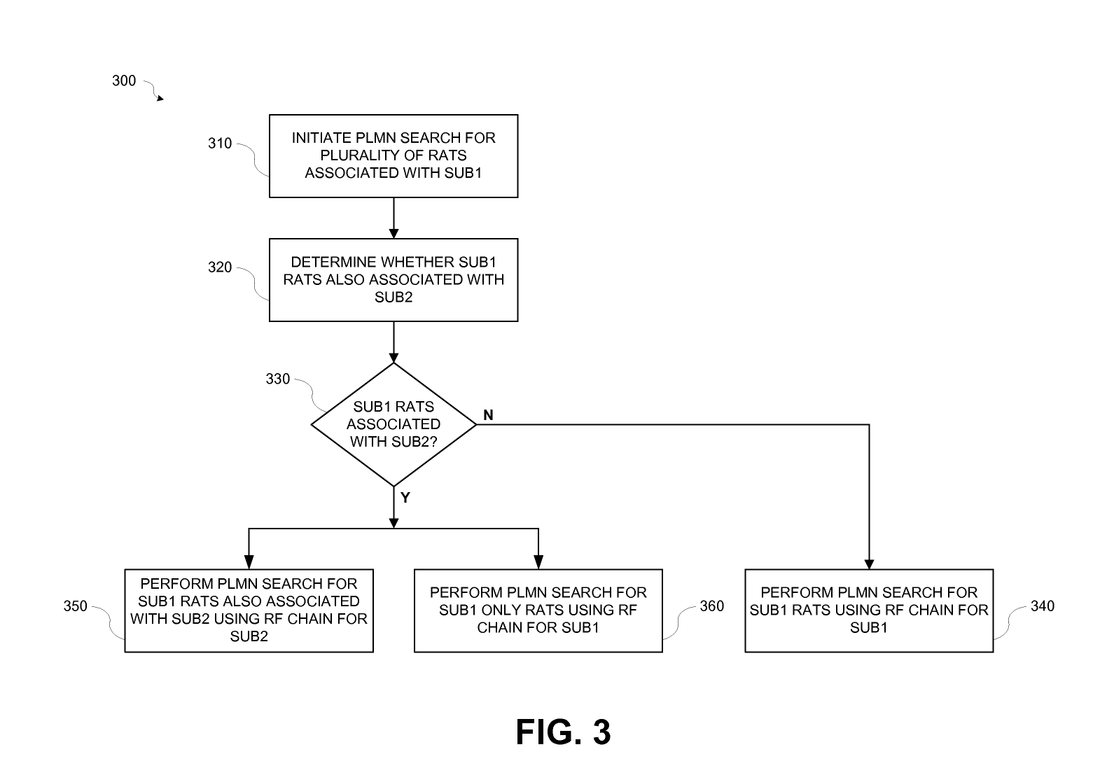

FIG. 3 is a flowchart of a method 300 for accelerating PLMN search according to various embodiments. The method 300 may be performed by the mobile communication device 100 (FIGS. 1-2), for example, by the control unit 110. Referring to FIGS. 1-3, a PLMN search may be initiated for a first plurality of RATs associated with a first subscription, for example Sub1 192 (210).

PLMN searches may be manually initiated based on input via the input device 172, for example, as a selection of a menu option displayed on the display device 174, or may be automatically initiated by the control unit 110 based on various operational conditions, for example, but not limited to, out-of-service (OOS) scanning, power-on acquisition, background and foreground PLMN scanning, circuit switched fallback (CSFB) redirection scanning, radio link failure (RLF) recovery scanning, limited service recovery scanning, etc.

The control unit 110 may determine if any of the first plurality of RATs associated with Sub1 192 are also associated with another subscription, for example Sub2 197 (320). If none of the first plurality of RATs associated with Sub1 192 are also associated with Sub2 197 (330-N), the control unit 110 may cause only the RF chain associated with Sub1 192 (e.g., the first RF chain 220) to perform the PLMN searches for the first plurality of RATs.

If one or more the first plurality of RATs associated with Sub1 192 are also associated with Sub2 197, i.e., are common to both Sub1 192 and Sub2 197, (330-Y), the control unit 110 may cause the RF chain associated with Sub2 197 (e.g., the second RF chain 225) to perform the PLMN searches for the one or more of the first plurality of RATs associated with Sub2 197 (350) simultaneously with PLMN searches for one or more of the first plurality of RATs associated only with Sub1 192 (360) performed on the RF chain associated with Sub1 192 (e.g., the first RF chain 220).

The PLMN searches for the one or more of the first plurality of RATs using the second RF chain 225 may performed during inactive periods of the Sub2 197 RATs while the Sub2 197 RATs are in idle mode. When the mobile communication device 100 is camped on a RAT supported by both subscriptions, the PLMN search for that RAT is performed using the RF chain of the communications unit through which the mobile communication device 100 is camped-on the RAT.

In various embodiments, PLMN searches for RATs on one subscription of a Multi-SIM, Multi-Active (MSMA) mobile communication device 100 may be divided among multiple RF chains based on RATs common to the subscriptions and the searches performed in parallel as explained.

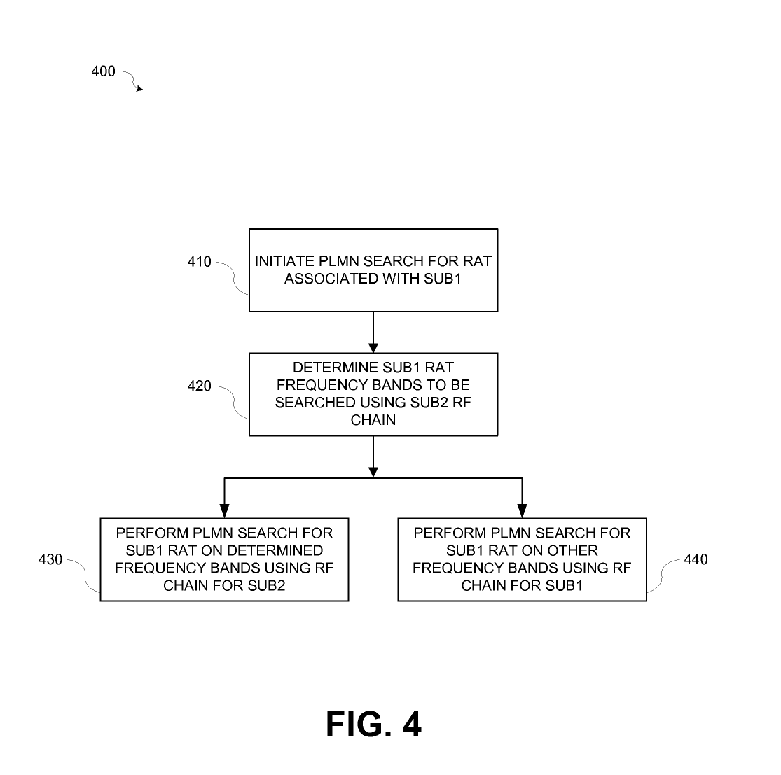

FIG. 4 is a flowchart of a method 400 for accelerating PLMN search according to various embodiments. The method 400 may be performed by the mobile communication device 100 (FIGS. 1-2), for example, by the control unit 110 and/or the like. Referring to FIGS. 1, 2, and 4, a PLMN search may be initiated for a RAT associated with a first subscription, for example Sub1 192 (410).

PLMN searches may be manually initiated based on input via the input device 172, for example, as a selection of a menu option displayed on the display device 174, or may be automatically initiated by the control unit 110 based on various operational conditions, for example, but not limited to, out-of-service (OOS) scanning, power-on acquisition, background and foreground PLMN scanning, circuit switched fallback (CSFB) redirection scanning, remote line failure (RLF) recovery scanning, limited service recovery scanning, etc.

The control unit 110 may determine one or more frequency bands from a plurality of frequency bands for the RAT associated with Sub1 192 to be searched using the RF chain associated with Sub1 192 (e.g., the first RF chain 220) and frequency bands of the RAT associated with Sub1 192 to be searched using the RF chain associated with Sub2 197 (e.g., the second RF chain 225) (420). For example, a PLMN search for GSM requires searching four possible frequency bands. The control unit 110 may determine that two of the frequency bands will be searched using the first RF chain 220 and the remaining two frequency bands will be searched using the second RF chain 225.

The control unit 110 may cause the RF chain associated with Sub2 197 (e.g., the second RF chain 225) to perform the PLMN searches on the one or more of the determined Sub1 192 RAT frequency bands (430) simultaneously with the PLMN searches on the one or more remaining Sub1 192 RAT frequency bands performed on the RF chain associated with Sub1 192 (e.g., the first RF chain 220) (440).

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for public land mobile network (PLMN) search on a mobile communication device, the method comprising:
initiating a PLMN search for a first plurality of radio access technologies (RATs) associated with a first subscription;
determining whether one or more of the first plurality of RATs associated with the first subscription are also associated with a second subscription; and
performing a PLMN search for the one or more of the first plurality of RATs that are also associated with the second subscription using an RF chain associated with the second subscription.

2. The method of claim 1, further comprising performing a PLMN search for RATs of the first plurality of RATs associated with only the first subscription using an RF chain associated with the first subscription simultaneously with the PLMN search using the RF chain associated with the second subscription.

3. The method of claim 1, wherein the PLMN search using the RF chain associated with the second subscription is performed during inactive periods of idle mode of RATs associated with the second subscription.

4. The method of claim 1, wherein the initiating a PLMN search comprises automatically initiating the PLMN search based on operational conditions of the mobile communication device.

5. The method of claim 4, wherein the operational conditions comprise at least one of out-of-service (OOS) scanning, power-on acquisition, background PLMN scanning, foreground PLMN scanning, circuit switched fallback (CSFB) redirection scanning, remote line failure (RLF) recovery scanning, and limited service recovery scanning.

6. The method of claim 1, wherein the initiating a PLMN search comprises manually initiating the PLMN search based on an input to an input device.

7. The method of claim 1, further comprising performing a PLMN search using an RF chain associated with the first subscription to perform the PLMN search for a RAT from the first plurality of RATs if none of the first plurality of RATs associated with the first subscription are also associated with a second subscription.

8. A method for public land mobile network (PLMN) search on a mobile communication device, the method comprising:
initiating a PLMN search for a radio access technology (RAT) associated with a first subscription;
determining one or more frequency bands from a plurality of frequency bands for the RAT to be searched using an RF chain associated with a second subscription; and
performing a PLMN search for the one or more determined frequency bands for the RAT associated with the first subscription using the RF chain associated with the second subscription.

9. The method of claim 8, further comprising performing a PLMN search using an RF chain associated with the first subscription for frequency bands for the RAT associated with the first subscription that are not searched using the RF chain associated with the second subscription simultaneously with the PLMN search using the RF chain associated with the second subscription.

10. The method of claim 8, wherein the PLMN search using the RF chain associated with the second subscription is performed during inactive periods of idle mode of RATs associated with the second subscription.

11. The method of claim 8, wherein the initiating a PLMN search comprises automatically initiating the PLMN search based on operational conditions of the mobile communication device.

12. The method of claim 11, wherein the operational conditions comprise at least one of out-of-service (OOS) scanning, power-on acquisition, background PLMN scanning, foreground PLMN scanning, circuit switched fallback (CSFB) redirection scanning, remote line failure (RLF) recovery scanning, and limited service recovery scanning.

13. The method of claim 8, wherein the initiating a PLMN search comprises manually initiating the PLMN search based on an input to an input device.

14. A mobile communication device, comprising:
a first RF chain associated with a first plurality of radio access technologies (RATs), wherein the first plurality of RATs is associated with a first subscription;
a second RF chain associated with a second plurality of RATs, wherein the second plurality of RATs is associated with a second subscription; and
a control unit configured to:
determine whether one or more of the first plurality of RATs are also common to the second plurality of RATs, and
perform a public land mobile network (PLMN) search for the one or more of the first plurality of RATs common to the second plurality of RATs using the second RF chain.

15. The mobile communication device of claim 14, wherein the control unit is configured to perform a PLMN search for RATs of the first plurality of RATs associated with only the first subscription using the first RF chain.

16. The mobile communication device of claim 14, wherein the control unit is configured to perform the PLMN search using the second RF chain during inactive periods of idle mode of RATs associated with the second subscription.

17. The mobile communication device of claim 14, wherein the control unit is configured to initiate the PLMN search based on operational conditions of the mobile communication device.

18. The method of claim 17, wherein the operational conditions comprise at least one of out-of-service (OOS) scanning, power-on acquisition, background PLMN scanning, foreground PLMN scanning, circuit switched fallback (CSFB) redirection scanning, remote line failure (RLF) recovery scanning, and limited service recovery scanning.

19. The mobile communication device of claim 14, wherein the control unit is configured to initiate the PLMN search based on an input to an input device.

20. The mobile communication device of claim 14, wherein the control unit is configured to perform the PLMN search for a RAT from the first plurality of RATs using the RF chain associated with the first subscription if none of the first plurality of RATs associated with the first subscription are also associated with a second subscription.

21. A mobile communication device, comprising:
a first RF chain associated with a first plurality of radio access technologies (RATs), wherein the first plurality of RATs is associated with a first subscription;
a second RF chain associated with one or more second RATs; and
a control unit configured to:
determine one or more frequency bands from a plurality of frequency bands for one of the first plurality of RATs to perform public land mobile network (PLMN) search using the second RF chain, and
perform a PLMN search on the one or more determined frequency bands using the second RF chain.

22. The mobile communication device of claim 21, wherein the control unit is configured to perform a PLMN search using the first RF chain for one or more frequency bands of the one of the first plurality of RATs other than the one or more determined frequency bands.

23. The mobile communication device of claim 21, wherein the control unit is configured to perform the PLMN search using the second RF chain during inactive periods of idle mode of the one or more second RATs.

24. The mobile communication device of claim 21, wherein the control unit is configured to initiate the PLMN search based on operational conditions of the mobile communication device.

25. The mobile communication device of claim 24, wherein the operational conditions comprise at least one of out-of-service (OOS) scanning, power-on acquisition, background PLMN scanning, foreground PLMN scanning, circuit switched fallback (CSFB) redirection scanning, remote line failure (RLF) recovery scanning, and limited service recovery scanning.

26. The mobile communication device of claim 21, wherein the control unit is configured to initiate the PLMN search based on an input to an input device.
